(19) United States
(12) Patent Application Publication
(10) Pub. No.: US 2013/0248256 A1
(43) Pub. Date: Sep. 26, 2013

(54) DRILL BIT OPTIMIZATION BASED MOTION OF CUTTERS

(71) Applicants: Reed W. Spencer, Spring, TX (US); Jonathan M. Hanson, Salt Lake City, UT (US)

(72) Inventors: Reed W. Spencer, Spring, TX (US); Jonathan M. Hanson, Salt Lake City, UT (US)

(73) Assignee: BAKER HUGHES INCORPORATED, Houston, TX (US)

(21) Appl. No.: 13/428,233

(22) Filed: Mar. 23, 2012

(51) Int. Cl. E21B 10/627; G06F 17/50

(52) U.S. Cl. 175/342; 703/1

(57) ABSTRACT

A method of designing a drill bit includes: defining a representation of a first drill bit including at least a first cutter having a first face, the first cutter being disposed on the representation of the first drill bit in a first orientation; simulating in a first simulation on a computing device off-axis rotation of the first drill bit in a simulated subterranean formation; determining that the first face included, during the first simulation, a first face orientation direction that was oriented different than a face cutting direction by an amount that exceeds a predetermined threshold; and defining the first drill bit such that the first cutter is disposed in a second orientation.

### BACKGROUND

Boreholes in earth formations for the purpose of producing fluids from earth formations such as for use in the production of oil or other hydrocarbons, or for the purpose of depositing fluids into earth formations, are usually drilled with a drill string that includes a tubular member having a drilling assembly (also referred to as the bottomhole assembly or “BHA”) that includes a drill bit attached to the bottom end thereof The drill bit is rotated by a motor included in the BHA so as to disintegrate the earth formations to drill the borehole.

As in most endeavors, in the drilling industry it is desirable to drill in an efficient manner. It is known that a drill bit can more efficiently penetrate into a formation when it rotates about a fixed rotational axis. When the bit rotates about a fixed rotational axis it is said to exhibit synchronous rotation. It is also known that certain physical phenomena can cause the rotation of the bit to vary from a synchronous rotation. Types of vibration include, for example, stick-slip, bit bounce and whirl. “Whirl” is used to describe the situation where the bit rotates about a moving rotational axis. One particular type of whirl is referred to as backward whirl can exist when one or more of the bit blades is moving in a direction opposite of motion direction of rotation of the bit.

While attempts are usually made to avoid effects such as whirl or other off-axis rotations of bit, in some cases such rotation is actually encouraged. For instance, in directional drilling where the drill string is purposely caused to follow a curved trajectory. Directional drilling involves placing a bent adjustable kick off (AKO) sub between the drill bit and the motor.

One type of rotary drill bit is the fixed-cutter bit, often referred to as a “drag” bit. These bits generally include an array of cutting elements coupled to a face region (blade) of the bit body. The bit typically includes several blades distributed generally around a central axis of the bit. A hard, abrasive material, such as mutually bonded particles of polycrystalline diamond, may be provided on a substantially circular end surface of each cutting element to provide a cutting surface. Such cutting elements are often referred to as “polycrystalline diamond compact” (PDC) cutters. In operation, a fixed-cutter drill bit is placed in a borehole such that the cutting elements are in contact with the earth formation to be drilled. As the drill bit is rotated, the cutting elements scrape across and shear away the surface of the underlying formation.

### BRIEF DESCRIPTION

According to one embodiment, a method of designing a drill bit for drilling subterranean formations is disclosed. The method of this embodiment includes: defining a representation of a first drill bit including at least a first cutter having a first face, the first cutter being disposed on the representation of the first drill bit in a first orientation; simulating in a first simulation on a computing device off-axis rotation of the first drill bit in a simulated subterranean formation; determining that the first face included, during the first simulation, a first face orientation direction that was oriented different than a face cutting direction by an amount that exceeds a predetermined threshold; and defining the first drill bit such that the first cutter is disposed in a second orientation.

According to another embodiment, a drill bit is disclosed. The drill bit of this embodiment is formed by a method that includes: defining a representation of a first drill bit including at least a first cutter having a first face, the first cutter being disposed on the representation of the first drill bit in a first orientation; simulating in a first simulation on a computing device off-axis rotation of the first drill bit in a simulated subterranean formation; determining that the first face included, during the first simulation, a first face orientation direction that was oriented different than a face cutting direction by an amount that exceeds a predetermined threshold; and defining the first drill bit such that the first cutter is disposed in a second orientation.

### BRIEF DESCRIPTION OF THE DRAWINGS

The following descriptions should not be considered limiting in any way. With reference to the accompanying drawings, like elements are numbered alike:

FIG. 1 is a downhole drilling and/or geosteering system disposed in a borehole 12;

FIG. 2 is an example of a fixed-cutter bit that may be designed according to the present invention;

FIG. 3 is side view of an individual PDC cutter;

FIG. 4 is flow-chart showing a method according to an embodiment of the present invention; and

FIG. 5 is an example of visual display that may be created according to an embodiment of the present invention.

### DETAILED DESCRIPTION

A detailed description of one or more embodiments of the disclosed apparatus and method are presented herein by way of exemplification and not limitation with reference to the Figures.

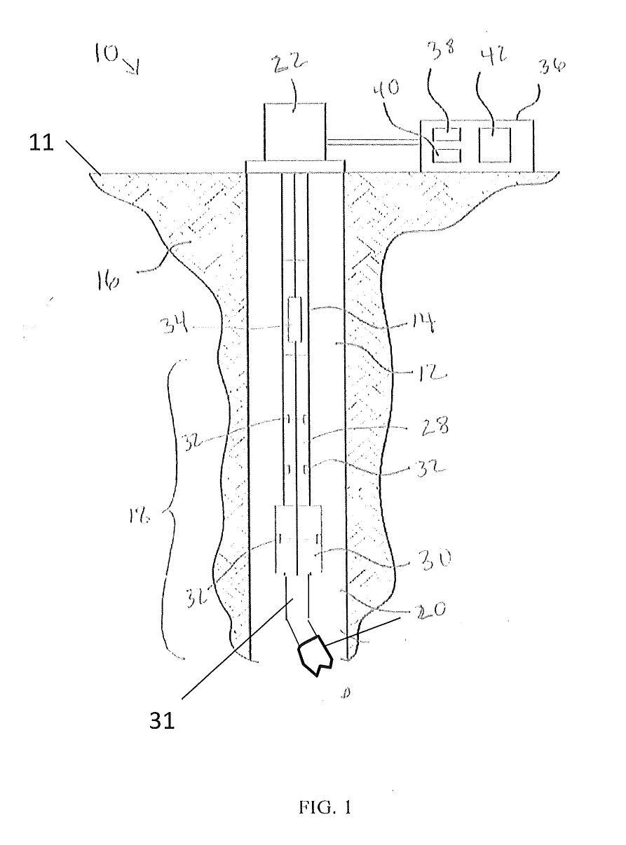

Referring to FIG. 1, an exemplary embodiment of a downhole drilling and/or geosteering system 10 disposed in a borehole 12 is shown. A drill string 14 is disposed in the borehole 12, which penetrates at least one earth formation 16. Although the borehole 12 is shown in FIG. 1 to be of constant diameter, the borehole is not so limited. For example, the borehole 12 may be of varying diameter and/or direction (e.g., azimuth and inclination). That is, in some instances, the borehole 12 may “curve” as it travels downward or may, in some instances travel in a horizontal direction relative to the surface 11.

The drill string 14 is made from, for example, a pipe or multiple pipe sections. A drilling assembly 18, which may be configured as a bottomhole assembly (BHA), includes a drill bit 20 that is attached to the bottom end of the drill string 14 via various drilling assembly components. The drilling assembly 18 is configured to be conveyed into the borehole 12 from a drilling rig 22. Exemplary drilling assembly components include the drill bit 20 that includes one or more cutters (not shown), a drilling motor 28 (e.g., a mud motor), and a stabilizer or reamer 30. In the embodiment shown in FIG. 1, the drill bit 20 is a drag bit but could be a roller cone bit having three cones, each cone including a cone shell and cutters (e.g., inserts or other cutting elements) that interact with the formation 16 during drilling. It shall be understood that the drill bit 20 could also be an impregnated diamond or a hybrid bit combining features of any of the bits described above.

In one embodiment, the drilling assembly 18 can include a bent AKO sub 31 disposed between the motor 38 and the drill bit 20. In one mode, referred to as “rotate mode,” both the drilling rig 22 and the drilling motor 28 are active and in another mode, referred to as “slide mode,” only the drilling motor 28 is active. Both of these modes are known modes utilized in directional drilling and are not discussed in particular further herein. Generally, however, it has been discovered that in rotate mode the discrepancy between a cutters orientation and direction of motion can vary more than in other modes.

In one embodiment, the drill bit 20 and/or drilling assembly 18 includes one or more sensors 32 and related circuitry for estimating one or more parameters relating to the drilling assembly 18. For example, a distributed sensor system (DSS) is disposed at the drilling assembly 18 and includes a plurality of sensors 32. The sensors 40 perform measurements associated with static parameters and/or the dynamic motion of the drilling assembly 18 and/or the drill string 14, and may also be configured to measure environmental parameters such as temperature and pressure or rock formation strength. Non-limiting example of measurements performed by the sensors include accelerations, velocities, distances, angles, forces, moments, and pressures. In one embodiment, the sensors 40 are coupled to a downhole electronics unit 34, which may receive data from the sensors 40 and transmit the data to a processing system.

A processing unit 36 is shown in FIG. 1 that may be utilized to generate, receive and/or process data relating to formation of a model of the drilling assembly 18 and/or the drill bit 20. The processing unit 36 may receive input data that is used to generate various models of the drilling assembly, including models that simulate performance of the drilling assembly during a drilling and/or steering operation.

In one embodiment, the processing unit 36 is connected in operable communication with the drilling assembly 18 and may be located, for example, at a surface location, a subsea location and/or a surface location on a marine well platform or a marine craft. The processing unit 36 may also be incorporated with the drill string 14 or the drilling assembly 18, or otherwise disposed downhole as desired. The processing unit 36 may be configured to perform functions such as controlling the drilling assembly 18, transmitting and receiving data, processing measurement data, monitoring the drilling assembly 18, and performing simulations of the drilling assembly 18 using mathematical models. The processing unit 36, in one embodiment, includes a processor 38, a data storage device (or a computer-readable medium) 40 for storing, data, models and/or computer programs or software 42.

Although the processing unit 36 is described as in communication with downhole components, it may also be configured as a stand-alone unit and provide processing for measurement data and/or simulation data without direct communication with a downhole system. The processing unit 36 may be configured as a single processor or multiple processors, such as a network, cluster or cloud of computers.

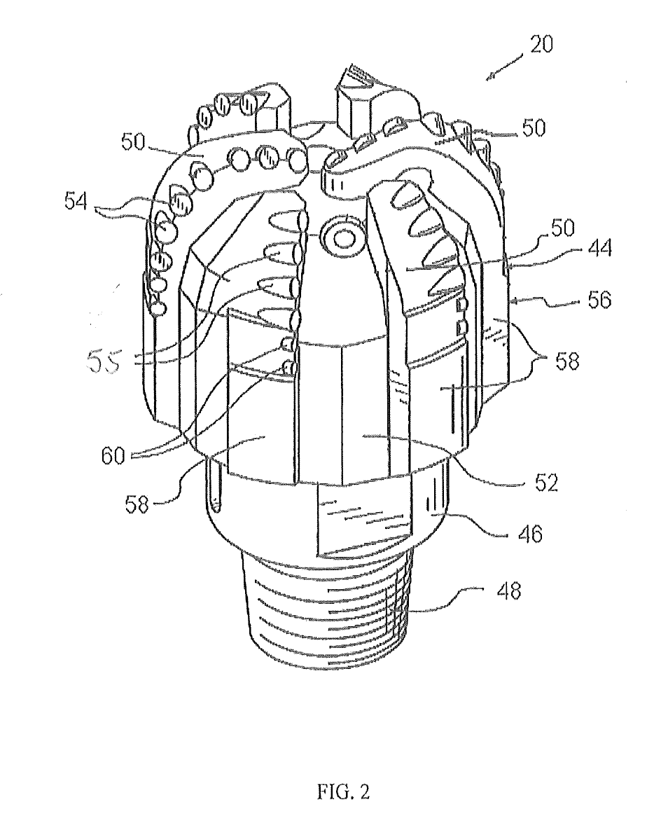

FIG. 2 shows an embodiment of an earth-boring rotary drill bit 20 configured as a fixed cutter bit (e.g., a PDC bit). The drill bit 20 includes a crown 44 and a bit body 24. The bit body 24 may include various components, such as a blank 46 connected to the crown 44, and a connection mechanism such as a threaded connection 48 for operably connecting the drill bit 20 to the drillstring or other components such as the mud motor 28 or reamer 30 (FIG. 1). The crown 44 includes wings or blades 50, which are separated by external channels or conduits also known as junk slots 52. A plurality of cutters 54 (e.g., PDC cutters) are disposed on the blades 50. Some or all of the cutters 54 includes a face that interacts with and cuts rock and that may be supported on a cutter body 55 (e.g., the non-sharp cylindrical portion of the cutter), that may also interacts with the formation by, for example, rubbing against the borehole wall and/or material that has been cut or crushed due to the cutters 54. The face can be formed, for example, of layers of polycrystalline diamond in one embodiment.

The bit body 24 also includes a bit gage 56. The bit gage includes gage pads 58, each of which is longitudinally adjacent to a respective blade 50. Gage trimmers 60 may be positioned within pockets located immediately adjacent and above gage pads 58. Further examples of components include other components that rub or contact the borehole wall or formation material in general, such as Tracblocks, ovoids, wear knots and others.

The embodiment shown in FIG. 2 is a fixed cutter bit such as polycrystalline diamond compact (PDC) bit. However, the drill bit 20 is not limited to the embodiments described herein, and may be any type or earth boring drill bit, such as a rotary drag bit, a roller cone bit, an impregnated bit, a hybrid bit and others.

Drilling assembly models may be generated to represent the drill bit 20 and/or other parts of a drilling assembly. The models are utilized to represent the geometry of the drill bit 20 as well as the orientation of the cutters 54 and, in particular, the orientation of the face of the cutters. With these models a simulation or prediction of the drill bit's 20 interaction with the formation during drilling, including the forces exerted on individual components of the drill bit that contact the formation. Thus, in some cases, the formation is also simulated and the processing unit 36 can be a standalone unit (or coupled to other computers) that is used for running simulations of drilling that can be used to design or modify drill bits.

The models may also include estimations or predictions of the amount of formation material or rock that is removed by the drilling assembly components. The models include development of mathematical and numerical techniques to better understand the influence on drill bit performance of bit body rubbing or other contact between drilling components and the formation. The models are not limited to describing drill bits, but can also include various components such as the drill string, reamers, stabilizers, and motor housing.

In one embodiment, the models can be used in a simulation to determine the orientation and motion vectors of the face of the drill bit cutter while drilling. In one embodiment, the relationship between these two vectors can be used to predict drill bit or cutter failure and/or to modify a drill bit design to avoid such failures.

The term “rock” is used herein to denote various types of mineral and other solid materials found in an earth formation, and is not meant to exclude any formation materials found or removed during a drilling operation. Formation materials may include material that has not previously been contacted (e.g., virgin rock) and materials modified by the drilling action (e.g., cuttings, particles, crushed rock).

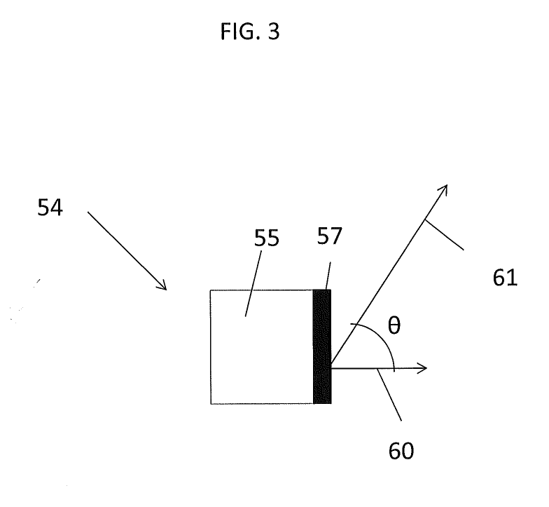

Referring now to FIG. 3, a detailed side-view depiction of a cutter 54 is illustrated. The cutter 54 includes a cutter body 55. As described above, the cutter body 55 can be cylindrical in shape but that is not required. The cutter body 55 includes a face 57. The face 57 is typically formed of a highly abrasive material such a polycrystalline diamond.

Actual operation of the systems/drill bit shown in FIGS. 1 and 2 have indicated that in some instances, one or more of the cutters 54 can have the face 57 removed from it while drilling. One reason that this could happen is that the cutter 54 may travel in such a manner that one or more of the sides of the cutter body 55 traverses the rock in a manner that the face 57 is pried off. For example, consider the cases of directional drilling or drilling while whirl exists. In either case, there may be instances where an orientation vector (e.g., vector 60 normal to the face 57) is at an angle (θ) relative to the motion of the cutter 54 (vector 61) that is large (or small, depending on the chosen orientations of vectors 60 and 61)) enough to cause damage to or removal of the face 57. In an extreme case, the orientation and motion vectors 60, 61 could be directed such that the body 55 is moving backwards relative to the orientation vector 60.

It shall be understood that the particular vectors shown in FIG. 3 are by way of example only. Any vectors that define an orientation of the face 57 or other portion of the cutter 54 could be utilized. For instance, the vector 60 could be defined as being tangent to the face 57. Similarly, the motion vector 61 could be defined by the force exerted on the blade/body/face or the direction of motion of the blade/body/face. In one embodiment, the relationship (e.g., angle (θ)) between the chosen orientation 60 and motion 61 vectors defines instances where possible damage to the face 57 or the cutter 54 could occur.

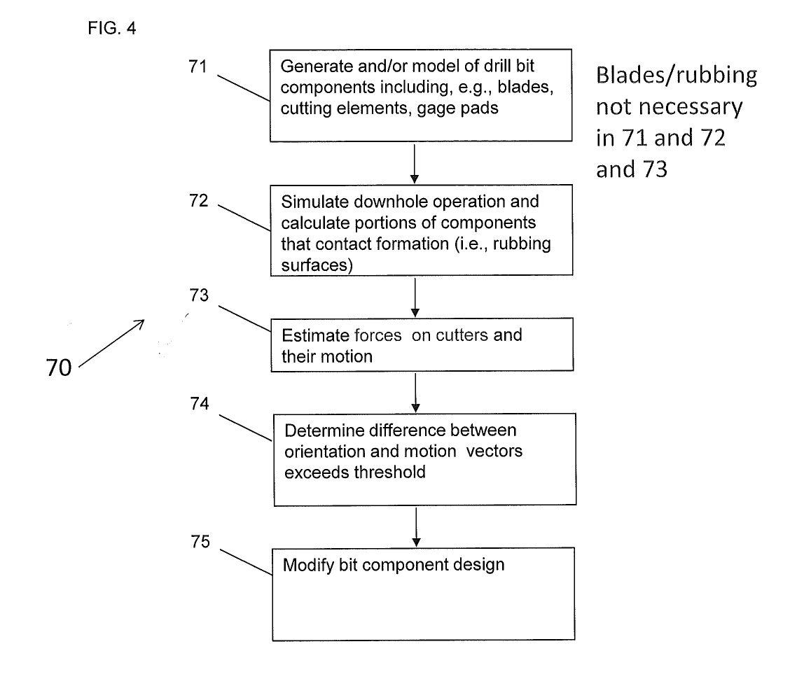

FIG. 4 illustrates a method of simulating the orientation and motion vectors experienced by one or more of the cutters 54. The simulation can focus on the bit alone or include information related to other elements (e.g., a drill string model) to which the bit may be attached. The method may be executed by a computer processing system (e.g., the processing unit 36) via programs or software for generating a drill bit and/or a drill string assembly model which may be used to investigate or predict the motion, velocity or other forces experienced by one or more of the cutters under selected downhole and drilling conditions. The method 70 includes one or more stages 71-75. In one embodiment, the method 70 includes the execution of all of stages 71-75 in the order described. However, certain stages may be omitted, stages may be added, or the order of the stages changed. For instance, while not illustrated in FIG. 4, the method could also include providing a visualization of the motion of the cutters during or after the simulation.

The method 70 may be performed via a single processor or multiple processors. For example, the method may be used with multiple processors, e.g., on a single machine with several processors, to run several simulations at a time. The method may also be used to preform one or more simulations via multiple processors such as a network, cluster or clouds. A single simulation may be performed in parallel on several processors or several simulations may be run simultaneously (on a single or multiple processors).

In the first stage 71, a model of the drill bit (possibly including the entire drilling assembly) is received and/or generated. The model includes three dimensional geometric data (e.g., size and shape) describing the drill bit. Included in this data may be an orientation vector that defines a direction relative to the face of the cutters. The vector can be, for example, normal or tangent to the face or any direction in between. Furthermore, representations may be generated for any of the various components of the drilling assembly, such as portions of the drill string (e.g., drill pipe segments), motor housing, reamers, drill bits and any other components of the drilling assembly that could potentially come into contact with the formation during drilling. Other components of the drilling assembly that may not come into contact with the formation may also be represented as desired.

In one embodiment, the model includes individual representations of each component (or one or more desired components) of the drill bit that can potentially contact the formation during a drilling operation. Examples of drill bit components include crowns, blades, gages, gage pads, cutters, grind flats on gage cutters, and roller cone shells. Other components that may be individually modeled include gage trimmers, Tracblocks, ovoids, wear knots and any other components that may rub or contact the borehole wall or formation material during a drilling operation.

The methods described herein are not limited to a particular type of drill bit, but may be utilized for any type of bit (with or without cutters). In addition to fixed cutter bits (e.g., PDC bits), other types of bits may be modeled, such as roller cone bits, hybrid bits, impregnated bits and any other type of bit that includes any surfaces that rub or otherwise contact the formation and/or borehole wall during a drilling operation.

In the second stage 72, the downhole operation of the drill bit is simulated. This can include determining which drill bit surfaces intact with the formation. The simulation, in one embodiment, includes causing the drill bit not only to rotate about an axis of rotation as well as causing the axis of rotation itself to travel in a path (e.g. a circle) within the borehole. Such can occur in actual operation in the case of actual directional drilling utilizing a bent AKO (adjustable kickoff) motor or when whirl is experienced. Either case may be referred to, with respect to the drill bit, as “off-axis” rotation herein.

In one embodiment, determining which drill bit surfaces (e.g, the blades and faces) or portions contact or interact with the formation includes determining whether nodes defining the borehole within an area defined by the 2D polygon(s) associated with a respective portion. This determination may be made individually for each component. This determination may be performed by any suitable algorithm, including fast algorithms for determining whether (in two dimensions) a point falls inside or outside a polygon, for example. Areas of contact between modeled components and the borehole are thus obtained. In one embodiment, the geometric model and contact calculations may be used to generate model(s) of contact forces, as well as models of rock removal by the components during drilling.

In the third stage 73, contact forces or the direction of motion of the rubbing surfaces (areas of an object that contact the borehole) are calculated and can be represented as vectors. These contact forces may be calculated individually for each modeled drill bit component. Contact force, in one embodiment, is calculated based on contact stress and the surface area of a rubbing surface (referred to as a “contact area”). In one embodiment, the contact forces/direction of motion (e.g., the motion vectors) are determined for the faces of one or more of the cutters on the drill bit.

Although the embodiments described herein include determining the intersection between 2D polygons and a borehole surface, they are not so limited. Any method or algorithm for determining an intersection between a component object and a borehole surface may be used. Any type of mathematical representation of the drilling assembly components and/or the borehole may be generated to determine an intersection between the borehole and surfaces of components. For example, the component(s) and/or the borehole surface may be represented by a polygon mesh, which may include many 2D polygons (i.e., greater than two) forming a 3D object. In one embodiment, the components are represented by polygon meshes and the borehole surface is represented by discrete elements (e.g., nodes). In another embodiment, both the components and the borehole surface are represented by polygon meshes, and intersection to determine contact area and force are calculated as mesh-mesh interaction between the components and the formation.

In the fourth stage 74, a difference between the orientation vector of the face and the motion of the cutter/face is determined. If the difference between these two vectors exceeds a certain threshold, the drill bit as a whole or the orientation of a particular cutter may be varied as indicated by the fifth stage 75. It shall be understood that variation of orientation can also include varying the location of the cutter on the drill bit.

In one embodiment, the orientation vector is defined to be normal to the face of the cutter. In such an embodiment, the threshold can be about plus or minus 20 degrees. Of course, other thresholds could be utilized if the definition of the orientation vector is varied from the normal without departing from the teachings herein. Furthermore, in some cases the threshold may include a time or other duration component. For example, in order the threshold to be exceeded, the orientation vector of the face relative to the motion of the cutter/face must exceed a particular angle for a specific amount of time or a percentage of rotations in the simulation.

Various parameters, such as drilling operation parameters and environmental parameters, may be input into the model and used to calculate, e.g., the depth of penetration and/or distance slid of component models and/or contact surfaces. Examples of such parameters include drilling fluid type, borehole temperature and pressure, and drilling parameters such as weight on bit (WOB), torque on bit (TOB), rotational rate (e.g., RPM) and steering direction.

It shall be further understood that the angle of a bent AKO can be varied in the simulations as a manner of effectuating a solution.

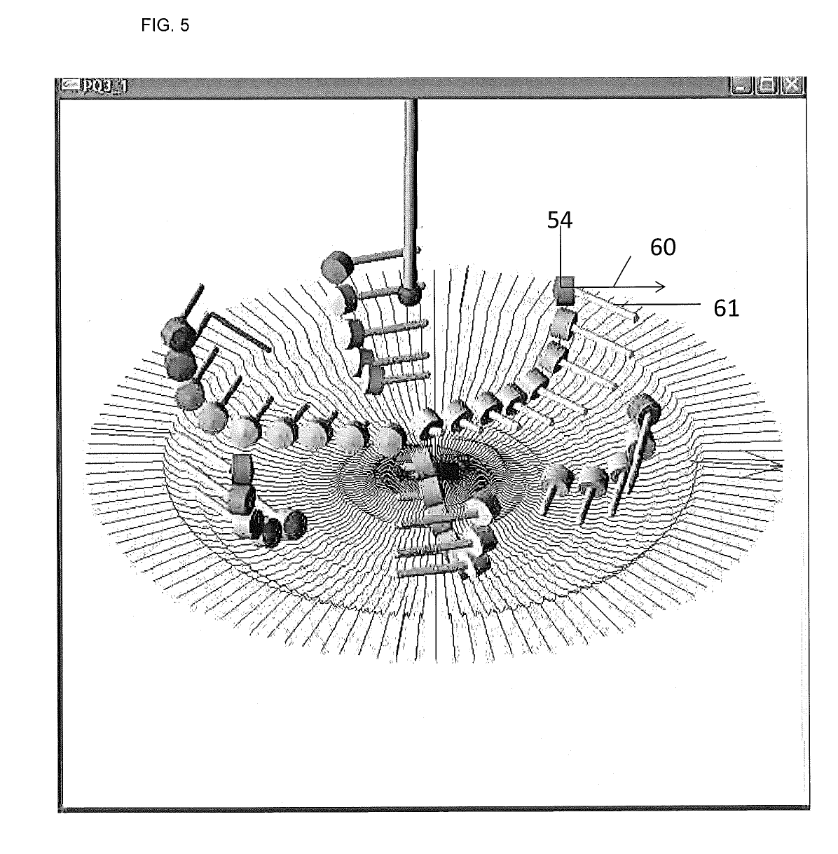

As described above, one embodiment can determine instantaneous orientation and motion vectors at any location on the bit and, in particular, at the face of a drill bit. It shall be understood that because this information is known, a representation/visualization such as shown in FIG. 5 can formed and displayed to a user. This illustration shows each cutter 54 and its instantaneous motion vector 61. In one embodiment, such a visualization can be provided at each instant or as a continuous collection of instants. Regardless, in one embodiment, an indicator such as color or the like, on the cutters 54 can be varied to indicate if the difference between the motion vector and orientation (e.g., face) vector exceeds a particular threshold. For instance, if the motion and orientation vector are within a predetermined relationship to one another, the cutter could appear green and then be switch to red if/when the vectors fall out of the predetermined relationship (e.g., the cutter is moving backwards).

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed:

1. A method of designing a drill bit for drilling subterranean formations, comprising:
defining a representation of a first drill bit including at least a first cutter having a first face, the first cutter being disposed on the representation of the first drill bit in a first orientation;
simulating in a first simulation on a computing device off-axis rotation of the first drill bit in a simulated subterranean formation;
determining that the first face included, during the first simulation, a first face orientation direction that was oriented different than a face cutting direction by an amount that exceeds a predetermined threshold; and
defining the first drill bit such that the first cutter is disposed in a second orientation.

2. The method of claim 1, further comprising:
simulating in a second simulation the rotation of the first drill bit having the first cutter in the second orientation in the simulated subterranean formation;
determining that the first face included, during the second simulation, a second face orientation direction that was oriented different than a second face cutting direction by an amount that was less than the predetermined threshold; and
creating a drill bit having the first cutter in the second orientation based on the second simulation.

3. The method of claim 1, wherein the first face orientation is defined by vector normal to first face.

4. The method of claim 3, wherein the first face cutting direction is defined by a velocity vector of the first cutter.

5. The method of claim 3, wherein the first cutting direction is defined by a force vector of the first cutter.

6. The method of claim 1, further comprising:
presenting a visualization of the motion of the first cutter on a screen based on the first simulation.

7. The method of claim 6, further comprising:
changing an attribute of the first cutter in the visualization based on the motion.

8. The method of claim 6, further comprising:
changing a color of the first cutter in the visualization first face orientation is oriented different than the face cutting direction by an amount that exceeds the predetermined threshold.

9. A drill bit formed by a method comprising:
defining a representation of a first drill bit including at least a first cutter having a first face, the first cutter being disposed on the representation of the first drill bit in a first orientation;
simulating in a first simulation on a computing device off-axis rotation of the first drill bit in a simulated subterranean formation;
determining that the first face included, during the first simulation, a first face orientation direction that was oriented different than a face cutting direction by an amount that exceeds a predetermined threshold; and
defining the first drill bit such that the first cutter is disposed in a second orientation.

10. The drill bit of claim 9, wherein the method further comprises:
simulating in a second simulation the rotation of the first drill bit having the first cutter in the second orientation in the simulated subterranean formation;
determining that the first face included, during the second simulation, a second face orientation direction that was oriented different than a second face cutting direction by an amount that was less than the predetermined threshold; and
creating a drill bit having the first cutter in the second orientation based on the second simulation.

11. The drill bit of claim 9, wherein the first face orientation is defined by vector normal to first face.

12. The drill bit of claim 11, wherein the first face cutting direction is defined by a velocity vector of the first cutter.

13. The The drill bit of claim 12, wherein the first cutting direction is defined by a force vector of the first cutter.
